(19) United States
(12) Patent Application Publication
(10) Pub. No.: US 2022/0159722 A1
(43) Pub. Date: May 19, 2022

(54) Rapid Uplink Access in 5G/6G and CDMA-CA Networks

(71) Applicants: David E. Newman, Poway, CA (US); R. Kemp Massengill, Palos Verdes, CA (US)

(72) Inventors: David E. Newman, Poway, CA (US); R. Kemp Massengill, Palos Verdes, CA (US)

(21) Appl. No.: 17/588,614

(22) Filed: Jan. 31, 2022

Related U.S. Application Data
(63) Continuation of application No. 17/375,051, filed on Jul. 14, 2021, now abandoned.
Application No. 17/375,051 is a continuation of application No. 17/106,431, filed on Nov. 30, 2020, now abandoned.
Application No. 17/106,431 is a continuation of application No. 17/028,018, filed on Sep. 22, 2020, now abandoned.
Application No. 17/028,018 is a continuation of application No. 16/819,546, filed on Mar. 16, 2020, now abandoned.
(60) Provisional application No. 62/832,499, filed on Apr. 11, 2019.
(60) Provisional application No. 62/843,867, filed on May 6, 2019.
(60) Provisional application No. 62/861,055, filed on Jun. 13, 2019.
(60) Provisional application No. 62/924,914, filed on Oct. 23, 2019.
(60) Provisional application No. 62/947,812, filed on Dec. 13, 2019.
(60) Provisional application No. 62/983,029, filed on Feb. 28, 2020.

(51) Int. Cl. H04W 74/08; H04L 1/18

(52) U.S. Cl. CPC H04W 74/0816; H04W 84/12; H04L 1/1812

(57) ABSTRACT

Disclosed herein are systems and methods for reducing wireless message collisions and enhancing throughput at high traffic density in 5G or 6G networks, by use of a shortened uplink request protocol. A short-form uplink request message is a message that has been reduced to just the essential parts for normal wireless communication, thereby substantially reducing the collision risk from hidden nodes in a network. In simulations, shortened request messages resulted in enhanced reliability, shorter delays, and reduced failure rates, leading to substantially improved network performance at high traffic density. Other types of shortened messages are also disclosed. The improved protocols can be incorporated at low cost in current and planned systems by software updates, while retaining the ability to receive and process legacy messages transparently, according to some embodiments.

### PRIORITY CLAIMS AND RELATED APPLICATIONS

This application is a continuation of U.S. patent application Ser. No. 17/375,051, entitled “Short RTS Messages for Rapid Wireless Communication”, filed Jul. 14, 2021, which is a continuation of U.S. patent application Ser. No. 17/106,431, entitled “Short RTS Messages for Rapid Wireless Communication”, filed Nov. 30, 2020, which is a continuation of U.S. patent application Ser. No. 17/028,018, entitled “Short RTS Messages for Rapid Wireless Communication”, filed Sep. 22, 2020, which is a continuation of U.S. patent application Ser. No. 16/819,546, entitled “Short RTS Messages for Rapid Wireless Communication”, filed Mar. 16, 2020, which claims the benefit of U.S. Provisional Patent Application No. 62/832,499, entitled “Autonomous Vehicle Localization System”, filed Apr. 11, 2019, and U.S. Provisional Patent Application Ser. No. 62/843,867, entitled “Identification and Localization of Mobile Robots”, filed May 6, 2019, and U.S. Provisional Patent Application No. 62/861,055, entitled “Rapid Wireless Communication for Vehicle Collision Mitigation”, filed Jun. 13, 2019, and U.S. Provisional Patent Application No. 62/924,914, entitled “Wireless Protocol for Improved Throughput and Fairness”, filed Oct. 23, 2019, and U.S. Provisional Patent Application No. 62/947,812, entitled “Short Pre-RTS Packets for Wireless Collision Avoidance”, filed Dec. 13, 2019, and U.S. Provisional Patent Application No. 62/983,029, entitled “Short RTS Messages for Rapid Wireless Communication”, filed Feb. 28, 2020, all of which are hereby incorporated by reference in their entireties. This application is also related to U.S. Pat. No. 9,896,096, issued Feb. 20, 2018, entitled “Systems and Methods for Hazard Mitigation” and U.S. patent application Ser. No. 16/148,390, filed Oct. 1, 2018, entitled “Blind Spot Potential-Hazard Avoidance System”, and U.S. patent application Ser. No. 16/503,020, filed Jul. 3, 2019, entitled “Rapid Wireless Communication for Vehicle Collision Mitigation”, U.S. patent application Ser. No. 16/422,498, filed Oct. 17, 2019, entitled “Identification and Localization of Mobile Robots”, and U.S. patent application Ser. No. 16/698,011, filed Nov. 13, 2019, entitled “Wireless Message Collision Avoidance with High Throughput”, and U.S. patent application Ser. No. 16/723,198, filed Dec. 20, 2019, entitled “Short Pre-RTS Packets for Wireless Collision Avoidance”, the contents of which are incorporated herein by reference in their entireties.

### FIELD OF THE INVENTION

The invention relates to systems and methods for low-latency, low-complexity access for uplink transmissions in both legacy and advanced wireless networks.

### BACKGROUND OF THE INVENTION

Before transmitting a data message, in advanced (5G or 6G) networks or low-complexity (CDMA-CA or “code-division multiple-access with collision-avoidance”) networks, a user node is required to obtain permission such as an uplink grant or a CTS grant. In an emergency situation, such as an imminent vehicle collision in traffic, the permission-request message wastes precious time, which could mean the difference between life and death.

What is needed is a permission-request protocol that takes less time.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY OF THE INVENTION

In a first aspect, a system for wireless communication includes a local area network (LAN) comprising a base station and a plurality of nodes, wherein the base station and the nodes are each configured to transmit and receive wireless radio-frequency messages, the base station is persistently associated with a medium access control (MAC) address, the base station is persistently associated with a local identification code which is shorter than the MAC address of the base station, and each node is configured to transmit an RTS message to the base station that includes the local identification code of the base station therein.

In a second aspect, a method for wireless communication between a node and a base station of a local area network includes transmitting, by the base station, a message specifying a base station local identification code which is non-transiently associated with the base station and has a length of at most 16 bits, transmitting, by the node, a message requesting admission to the local area network, transmitting, by the base station, a message specifying a node local identification code which is non-transiently associated with the node and includes at most 16 bits, and transmitting, by the node, an RTS message that includes the base station local identification code and the node local identification code therein.

In a third aspect, a local area network includes a plurality of nodes, each node comprising a processor, a transmitter, and a receiver, and a base station comprising a processor, a transmitter, and a receiver, wherein each node is configured to initiate wireless communication by transmitting an RTS message, the RTS message includes a first portion identifying the transmitting node and a second portion identifying the base station, the RTS message includes a third portion indicating an interval of time, and the RTS message has a length of less than 224 bits.

In a fourth aspect, a wireless communication system includes a base station and a plurality of nodes wherein each node is configured to transmit an RTS message having at least one of the following features: (a) the first 8 bits of the RTS message comprise an SFD having a bit pattern of ‘10101011’, (b) the RTS message does not include a Preamble of alternating ‘1’ and ‘0’ bits separate from the SFD, (c) the RTS message includes a Frame Type portion of at most 4 bits that indicates the type of message as an RTS message, (d) the RTS message includes a Receiver Local ID Code that is persistently associated with the base station and is at most 12 bits in length, (e) the RTS message includes a Transmitter Local ID Code that is persistently associated with the transmitting node and is at most 12 bits in length, (f) the RTS message includes a Duration portion indicating a contention-free time interval and is at most 8 bits in length, (g) the RTS message includes a Frame Check portion indicating whether the RTS message is corrupted and is at most 4 bits in length, and (h) the RTS message is at most 48 bits in length.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

These and other embodiments are described in further detail with reference to the figures and accompanying detailed description as provided below.

### BRIEF DESCRIPTION OF THE DRAWINGS

FIG. 1 is a sketch showing an exemplary LAN including an array of mobile phones representing nodes around a base station, according to some embodiments.

FIG. 2A is a sequence chart showing a series of messages including a prior-art communication.

FIG. 2B is a sequence chart showing an exemplary series of messages including a short-form RTS, according to some embodiments.

FIG. 3A is a sequence chart showing parts of a prior-art non-short RTS message.

FIG. 3B is a sequence chart showing parts of an exemplary short-form RTS or CTS message, according to some embodiments.

FIG. 3C is a schematic showing bits of a prior-art Preamble and Start Frame Delimiter, along with an exemplary Start Frame Delimiter of an exemplary short-form RTS message, according to some embodiments.

FIG. 3D is a schematic showing bit positions of the Frame Control and the Frame Check Sequence of a prior-art non-short RTS message, along with an exemplary Frame Type portion and a Frame Check portion of an exemplary short-form RTS message, according to some embodiments.

FIG. 3E is a schematic showing bit positions of the Duration portion of a prior-art non-short RTS message, along with an exemplary Duration portion of an exemplary short-form RTS message, according to some embodiments.

FIG. 3F is a schematic showing the bit positions of the Transmitter Address portion of a prior-art non-short RTS message, along with an exemplary Transmitter Local ID Code portion of an exemplary short-form RTS message, according to some embodiments.

FIG. 3G is a schematic showing the bit positions of the Receiver Address portion of a prior-art non-short RTS message, along with an exemplary Receiver Local ID Code portion of an exemplary short-form RTS message, according to some embodiments.

FIG. 4A is a sequence chart showing parts of a prior-art non-short ACK message.

FIG. 4B is a sequence chart showing parts of an exemplary short-form ACK message, according to some embodiments.

FIG. 4C is a sequence chart showing parts of another exemplary short-form ACK message, according to some embodiments.

FIG. 4D is a sequence chart showing an exemplary Double ACK message, according to some embodiments.

FIG. 5A is a sequence chart showing an example of how a Start Frame Delimiter byte may be used to align the timebase of a receiver, according to some embodiments.

FIG. 5B is a flowchart showing an exemplary method for a receiver to align its signal processing parameters to a Start Frame Delimiter, according to some embodiments.

FIG. 6 is a schematic illustration of multiple LANs in close proximity, according to some embodiments.

FIG. 7 is a flowchart showing an exemplary series of messages between a base station and a newly arriving node, according to some embodiments.

FIG. 8 is a flowchart showing an exemplary method for a base station to determine whether a short-form RTS message is corrupted, according to some embodiments.

FIG. 9 is a chart showing the success rate of nodes in a simulated LAN using exemplary RTS messages of various lengths.

FIG. 10 is a chart showing the average delay time of messages in a simulated LAN using exemplary RTS messages of various lengths.

FIG. 11 is a chart showing the message failure rate of nodes in a simulated LAN using exemplary RTS messages of various lengths.

FIG. 12 is a chart showing the collision rate of nodes in a simulated LAN using exemplary RTS messages of various lengths with Incrementation and Decrementation delay protocols.

FIG. 13 is a chart showing an exemplary formula for setting the contention window parameters in a LAN using an exemplary Decrementation protocol.

Like reference numerals refer to like elements throughout.

### DETAILED DESCRIPTION

Systems and methods are disclosed herein (the “systems” and “methods”, also occasionally termed “embodiments” or “arrangements”, generally according to present principles) that can provide urgently needed wireless communication protocols to increase wireless throughput and avoid message collisions at high traffic density, according to some embodiments. Embodiments of the systems and methods may include shortened or abbreviated RTS messages (the “short-form RTS messages”) which are RTS messages that include one or more of the improvements disclosed herein, in contrast to prior-art “non-short” RTS messages that do not include such improvements. Wireless communications generally occur within a LAN (local area network), which generally includes a plurality of independent stations or “nodes” communicating with a central or supervisory “base station” (also called an “access point”). Short-form RTS messages may avoid collisions by use of a shortened or abbreviated RTS message, thereby reducing a collision vulnerability window. Messages following the RTS messages may be protected by a Reserve (or NAV or contention-free) state that prevents interference, but the RTS message is not protected because the Reserve state begins after the RTS message has finished. A shorter RTS message is therefore less likely to be collided by another node's message. Examples are presented for ways to construct short-form RTS messages as well as short-form CTS, DAT, and ACK messages. Short-form messages are messages that include at least one of the following: a SFD that incorporates the functions of a Preamble, a shortened Duration datum that indicates a requested contention-free time interval in suitable time units, shortened address identifiers for the transmitting and/or receiving nodes, abbreviated message-type indicators, abbreviated FCS error codes, elimination of a Preamble, and/or elimination of fixed data that can be established in advance using management messages. Depending on which items are included in the short-form message, the short-form messages may have a length of 32 or 40 or 48 or 64 or 80 or 128 or 216 bits, or less than 224 bits, for example. For comparison, non-short RTS messages are typically 224 bits long, and non-short ACK messages are typically 176 bits long. In embodiments, a base station may receive and interpret nodes that use short-form messages as well as nodes that use non-short messages. In addition, a node may revert to the non-short RTS message protocol when necessary, such as when they require the explicit parameterization that non-short messages provide. It is intended, however, that most messages can use short-form RTS messages most of the time in most LAN situations, thereby obtaining the benefit of reduced collisions, higher throughput, fewer failed or dropped messages, lower power consumption, and shorter delays, according to some embodiments. Another advantage may be that, with shorter RTS, CTS, and ACK control messages, the RTS threshold may be adjusted lower, without penalty in performance. The “RTS threshold” is a predetermined size of a DAT message, such as 500 bytes, such that DAT messages shorter than the threshold may be sent without the RTS/CTS handshake, while DAT messages longer than the threshold are required to use the RTS/CTS to gain exclusivity of the channel. With shorter control messages and a lower RTS threshold, a larger fraction of the messages may be regulated, thereby improving network communications overall. Another advantage may be that the shorter control messages may reduce the burden of providing so-called “protection”, or compatibility with older 802.11b protocols, which otherwise may use up a substantial fraction of the channel and negate much of the benefits of high speed transmissions. Other advantages and benefits are discussed in the examples below.

Most of the examples are based on the CSMA/CA (carrier-sense multiple-access with collision avoidance) protocols which stem from the IEEE 802.11 protocols; however, embodiments of the disclosed systems and methods may be beneficially applicable to other wireless communication protocols as well. Enhancements such as QoS (quality of service), multiple-frequency systems, fragment management, data rate optimization, various modulation and noise-cancellation methods, and other variations are not specifically discussed; however, these and other variations may benefit from the disclosed systems and methods, as will be recognized by one of ordinary skill in the art given this disclosure. As used herein, a “wireless message” is information transmitted by radio-frequency waves. An “RTS message” (without modifier) includes both short-form RTS messages and non-short RTS messages. An RTS message is a message sent by a transmitting node, typically to the base station, requesting permission to send a data packet. A CTS message is a message sent by the base station or receiving node in reply to an RTS, granting that permission. A DAT message is a longer message that a node sends upon receiving a CTS message. An ACK message is a message sent by the base station or receiving node, indicating that the DAT message was received in good order. “Control” type messages include the RTS, CTS, and ACK messages, whereas “data” type messages include DAT messages. A “byte” is 8 bits. When bits are numbered in the examples below, for clarity the numbering starts with 1, rather than 0. In reference to message components including bits, “length” means the number of bits in the component, “shorter” means having fewer bits, and “longer” means having more bits. In reference to time intervals such as delays, “length” means the amount of time in the interval, “shorter” means less time, and “longer” means more time. A “slot” is a unit of time which typically includes a small number of bytes, such as 6 or 10 or 14 bytes, of transmitted data. In some LANs, a slot represents the maximum amount of time required for a message to travel from any node to the base station, or alternatively to a round-trip travel time between the base station and a node, including receiver lag. A slot time may be as short as 1 to 5 microseconds, or shorter, in a compact or high-frequency LAN with high modulation rates, and may be as long as 10 or 20 or 100 microseconds, or longer, for an extended LAN. In some of the examples below, a slot is set at 6 bytes; however the slot length and transmission rate may be different in each particular LAN arrangement. In examples, time may be demarked in bits or bytes or slots or microseconds or words or symbols or other suitable time units, as appropriate. A “timebase” or “time base” is a time scale, usually determined by an oscillator in a receiver, and usually including a variable time offset capability. A “sequence chart” is a chart showing items, such as bits or messages or message components or intervals, sequentially in time, such as an oscilloscope trace or a logic analyzer display.

A wireless communication may be termed a “packet”, a “message”, or a “frame” interchangeably herein. A “node” is a communication device that includes a wireless transmitter, a receiver (or a transceiver), and a processor configured to analyze signals from the receiver and to cause the transmitter to transmit messages. Examples of nodes include mobile phones, smart sensors, personal computers, automated industrial machines, and interconnected vehicles, among the many types of devices configured to communicate wirelessly. A base station may include an interface between wired and wireless domains using a router or an Ethernet link, for example. A base station may manage the timing and other parameters of the LAN, for example by updating the parameters and communicating the updates to the nodes by periodically transmitting “beacon” messages, which are management messages transmitted by the base station to all the nodes of a LAN. In some LAN configurations, the nodes communicate only with the base station, while in other configurations the nodes can communicate directly with each other. Base stations may also manage communications between adjacent LANs, for example by exchanging messages or other information using a wired connection or other communication medium, which is usually but not always distinct from the wireless medium employed by the nodes. Communication links from a base station to the wider network infrastructure are treated as “wired” herein, although they may include conductive cables, optical fibers, microwave beams between fixed sites, satellite links, etc. Unless otherwise specified, the examples provided herein assume an isolated, managed LAN without direct node-node communication. “Traffic” is the amount of wireless communication detected by each of the nodes or by the base station (not to be confused with vehicle traffic). A “collision” is interference between two simultaneous wireless messages on the same channel or frequency, generally resulting in both messages being garbled (not to be confused with physical collisions between vehicles). The terms “message-collision” and “vehicle-collision” may be used to avoid possible confusion. A “channel” is a frequency band used for wireless communication. The “traffic density” is a measure of the amount of communication on a channel. In examples herein, the wireless traffic density may be represented by a parameter P, which equals 10 million times the probability that a particular node initiates a new RTS message in a particular time slot. For example, a traffic density P of less than about 700 generally represents a low traffic density in which collisions are rare and most nodes can transmit at will or with minimal delay. A traffic density P in the range of about 700 to about 2500 corresponds to a medium traffic density in which nodes are likely to experience a small number, such as one or two, delays before completing a message. A traffic density P of greater than about 2500 generally corresponds to high traffic density in which most nodes spend most of the time in a backoff state waiting for a chance to transmit. A “message completion” is a complete RTS-CTS-DAT-ACK sequence transmitted and received in good order. The message “throughput” or “success rate” S equals the number of message completions per one million slots. The message “failure rate” F is the number of messages that are ultimately dropped due to having been delayed an excessive number of times. In examples, a message that has been delayed 20 or more times is considered to have failed, and is dropped. The “average delay time” D is the average amount of time that a node spends in a delayed or backoff state, per million slots. “Backoff” refers to a required delay in transmission when the medium is busy. The “collision rate” C is the number of message collisions per million slots. An RTS, CTS, or DAT message has been “successfully transmitted” and “successfully received” when the intended recipient receives it; the two terms are used interchangeably herein. A “confirmatory reply” for an RTS is a CTS, for a CTS is a DAT, and for a DAT is an ACK. There is no confirmatory reply for an ACK. “Congestion” or “saturation” is a condition in which the wireless traffic density is so high that most of the nodes spend most of their time waiting for a chance to send their messages. A “carrier signal” is a radio-frequency signal indicating that a message is in progress or is imminent. A node is “blocked” if it is forced to delay indefinitely while other nodes, with the same status or priority, are permitted to transmit multiple times. A “Local ID Code” is an identification code persistently and specifically representing a particular node or base station. The nodes of a LAN all have different Local ID Codes and different from that of the base station. Base stations of adjacent LANs, or that are within detectable signal range of each other, also have different Local ID Codes. If a base station detects a message from another LAN using the same base station Local ID Code, that base station can change its own Local ID Code to maintain distinction, and then inform the various nodes in its LAN of the change. The Local ID Code of a node or base station may be shorter than the MAC address of that node or base station, such as 8 or 12 or 16 or 24 bits or less than 48 bits in length. (MAC stands for Media Access Control.) For example, the Local ID Code of a node or base station may be long enough to provide a different code for each node in a LAN, and also a different code for each base station that is within detectable signal range of another LAN. The base station may broadcast its Local ID Code in a beacon message, and may assign a distinct Local ID Code to each of the nodes in the LAN respectively. A “backoff delay” is a delay imposed on a node due to a collision or to another message which is already in progress when the node is ready to transmit. A backoff delay includes a predetermined “waiting interval”, plus a randomly selected portion “Rand” of a predetermined contention window. A “contention window” CW is a predetermined interval of time during which a node may transmit a message, unless the channel is already busy. “Random” and “pseudorandom” are treated as equivalent herein. A node wishing to send a message may select, at random, a portion of the contention window, and may transmit after the waiting interval plus the randomly-selected portion of the contention window, and may then transmit unless another node is already transmitting at that time, in which case the ready node must again perform another backoff delay. Some references refer to the waiting interval as “CWmin”, meaning the starting time of the contention window. Likewise “CWmax” is the time of the end of the contention window, and “CWwid” is the width of the contention window. Thus, CWmax=CWmin+CWwid. The total backoff delay equals CWmin plus a random number (ranging from 0 to 1) times CWwid. In engineering terms, the contention window is a delayed gate, wherein the gate is the contention window, and the gate delay is the waiting interval. Backoff delays are intended to spread out the transmission attempts, thereby preventing multiple nodes from transmitting at the same time. However, if the backoff delay is too long, throughput may be reduced. To avoid having multiple transmissions starting at the same time, each node wishing to transmit may first sense whether the medium is busy by detecting any wireless messages or carrier signals that may be present. If no carrier signal is present, the node determines that the channel is clear, and the node may transmit. If the node detects the carrier signal of another message already in progress, the node must wait until the competing message has ended, then wait for the waiting interval, and then wait an additional randomly selected portion of the contention window, and may then begin transmission (unless another node has already started transmitting at that time). On the other hand, if the node wishing to transmit is already in a backoff delay, then the node may simply stop timing its backoff delay while the other transmission is in progress, and then resume timing the backoff delay as soon as the channel is clear. In this way, the nodes compete for an opportunity to transmit while avoiding some types of collisions. A “Preamble” is a message portion, usually the first portion of a message, consisting of alternating ‘1’ and ‘0’ bits to allow a receiver to align its timebase and demodulator to the message that follows. An SFD or Start Frame Delimiter is a message portion, usually a single byte, indicating that the message data follows. The Preamble and SFD are treated as part of the message herein, notwithstanding that they may be prepended to a sender's data by the transmitter, for example.

To avoid collisions, a node may request a “Reserve” interval of a given duration, which normally is the total duration of a CTS, DAT, and ACK sequence (plus spaces, etc.). The Reserve or NAV interval may be called a “contention-free” interval since the various nodes are configured to refrain from transmitting for the amount of time specified. The base station may confirm or approve the Reserve request by repeating the duration value in the responsive CTS message (optionally after subtracting the duration of the CTS message from the Reserve interval). The Reserve interval requested by an RTS message may be termed an RTS-Reserve, while that specified by the CTS may be called a CTS-Reserve, to keep these two types separate. The Reserve interval is sometimes called a NAV or Network Allocation Vector. When implemented in a LAN, a Reserve interval may prevent collisions by suppressing transmissions, but only after the RTS message has completed. Collisions may occur during the RTS message because the nodes recognize the Reserve status only after detecting the RTS message; hence the RTS itself is unprotected. For example, two nodes may start transmitting two separate RTS messages simultaneously (that is, in the same slot), or a first node may transmit a first RTS message while a second and “hidden” node is transmitting a second RTS message, causing a collision. A hidden node, as viewed by the first node, is a node of the LAN that is too far away from the first node to detect transmissions from the first node. All nodes in a LAN can detect communications from the base station, and the base station can detect communications from all of the nodes in the LAN; hence none of the nodes is hidden as viewed by the base station. The number of hidden nodes in a LAN depends on their spatial distribution, their transmitter power, any intervening absorbers or scatterers, and other factors. The “hidden node problem” is a tendency for two nodes that are hidden from each other to transmit messages that collide. The Reserve state, imposed by an RTS or CTS message based on the Duration datum, largely resolves the hidden node problem for the remainder of the message sequence, although the RTS message itself remains vulnerable.

A “transmission failure” or “failed transmission attempt” is a wireless message that was not received by the intended recipient in good order. Such failure may be due to a wireless collision or other interference or noise for example. From the point of view of a node, a failed transmission attempt is an RTS which is not followed by a CTS, or a DAT which is not followed by an ACK, within a predetermined “listening” time interval. A failed transmission may also be a commit-to-send while a carrier signal is detected, or a commit-to-send while a Reserve interval is in effect. In each case of a failed transmission, a backoff delay is “required”, that is, the node is obligated to delay for a waiting period plus a randomly selected portion of a contention window, and only then may again attempt a transmission. The length of a backoff delay may be adjustable according to the number of times the node has tried to send the message, and/or other parameters. For example, in a protocol termed “binary exponential backoff”, each node must double its backoff delay window after each failed attempt, thus increasing its next delay on average after each backoff, up to a predetermined maximum delay. When the message is finally transmitted successfully, the node reverts back to the initial short delay time for its next message. In this way, the nodes can accommodate high traffic density by increasing their backoff delays, while still using very short delays when the traffic density is low. Such delay protocols, in which the average delay is increased upon each retry, may be termed “Incrementation” protocols since the delay is incremented or increased upon each attempted transmission. In contrast, other protocols, termed “Decrementation” protocols, may be configured to reduce the average delay upon each successive backoff event. An advantage of the Decrementation protocols may be that they can provide a competitive advantage to nodes that have waited the longest, whereas the Incrementation protocols give a competitive advantage to nodes that have not been delayed at all. This intrinsic unfairness of the Incrementation protocols results in inequality and a drag on system resources generally. As used herein, “fairness” means providing a competitive advantage to nodes that have waited longest, relative to other nodes that have not waited so long. “Equality” means providing equal transmission opportunities to all the nodes in a LAN. The “blocked-node problem” is a form of congestion at high traffic density in which one or more nodes in a LAN are forced to remain in a backoff state indefinitely while other nodes are permitted to transmit repeatedly, which is a characteristic of the Incrementation protocols.

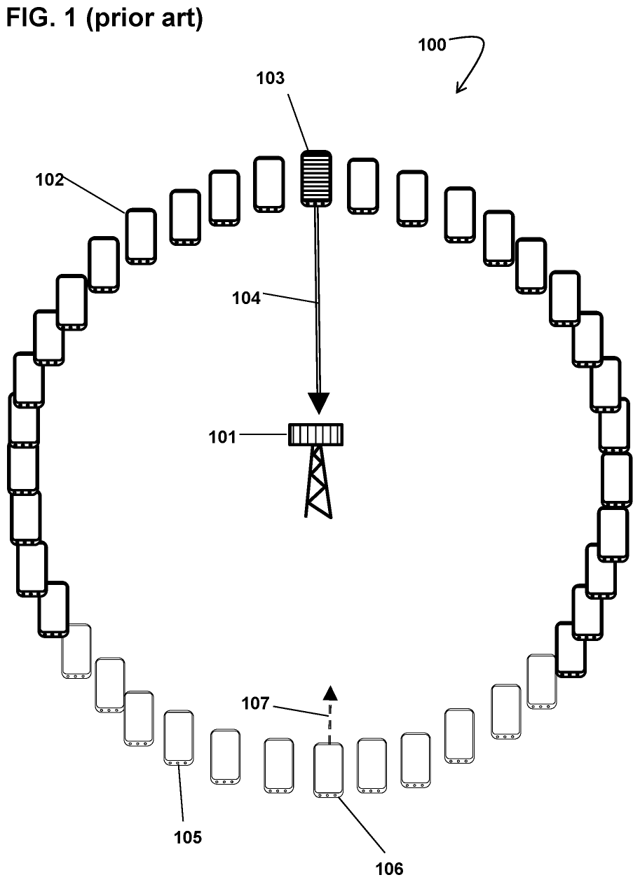

Turning now to the figures, FIG. 1 is a sketch showing an exemplary LAN 100 including an array (in this case 40) of mobile phones representing nodes 102 around a base station 101, according to some embodiments. As viewed by a particular node 103, twelve other nodes 105 are hidden and thus are shown in lightline. To illustrate the importance of the length of the RTS message, two possible scenarios are envisioned. In a first scenario, the owner of the particular node 103 is being kidnapped, but has one brief opportunity to call for help, which is the RTS message 104. However, one of the hidden nodes 106, which is unaware of the ongoing RTS 104, is about to send its own RTS message 107. If the two messages 104 and 107 collide, the emergency message 104 will be collided and the emergency call will not go through, thereby costing an innocent life. Fortunately, in this example, the particular node 103 is equipped with advanced networking software that generates a short-form RTS message. Due to its brief duration, the short-form RTS message is completed before the other message 107 has started; hence the emergency call went through and the victim was saved. If, on the other hand, the particular node 103 had used a prior-art non-short RTS instead, it would have been collided by the competing message 107, and the outcome would have been tragically different.

In a second scenario, involving highway safety, the particular node 103 represents a vehicle traveling on a freeway, and the base station 101 represents a roadside access point for vehicle communications. Road conditions are poor, with low visibility. The vehicle has detected, using radar for example, a stalled vehicle in front, and an accident is about to occur. There is no time to stop despite maximally activating the brakes, but there may still be time to send a quick help message before impact. The RTS message 104 represents a request for immediate first-responder assistance, and also to ask the network to warn any approaching vehicles to slow down and thereby avoid causing a multi-vehicle pileup. Unfortunately, another node in the LAN is about to send another message 107 at almost the same time. The likelihood of the emergency RTS message 104 being collided is proportional to the length of the RTS message 104. In a very short time, the vehicle will have struck the one in front, and its transmitter will no longer be able to send messages. Therefore, there is considerable urgency in getting the RTS 104 through on the first try. A short-form RTS message, being shorter than a prior-art non-short RTS, is more likely to get through without interference, which is a significant advantage in high-density conditions. While these two emergency scenarios may seem contrived, they represent just two cases in a myriad of applications where prompt communication is essential, illustrating the need for shorter RTS messages to reduce the probability of interference in wireless networking.

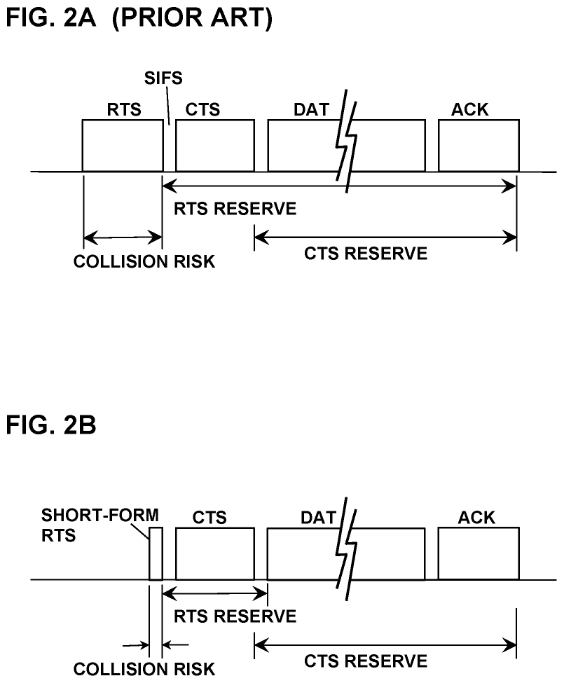

FIG. 2A is a sequence chart showing a series of messages including a prior-art communication. A prior-art non-short RTS message is followed by a CTS, DAT, and ACK sequence which together form a successful communication of data. (The long DAT message is shown truncated, to fit on the page.) SIFS (Short Inter-Frame Space) gaps between the messages are also shown. An interval labeled “RTS Reserve” shows a time period, given by a Duration datum in the RTS, during which the other nodes in the LAN are obligated to refrain from transmitting. An interval labeled “CTS Reserve” shows a second interval, starting after the CTS and extending to the end of the ACK, during which nodes are not to transmit, based on a Duration datum in the CTS. Such exclusion intervals are sometimes termed NAV. As indicated by the “Collision Risk” label, the entire RTS message is at risk of a collision from other nodes, principally by hidden nodes since they cannot detect the RTS transmission and may unknowingly send a message during the RTS.

FIG. 2B is a sequence chart showing an exemplary series of messages including a short-form RTS, according to some embodiments. The CTS, DAT, and ACK messages are the same as in FIG. 2A in this embodiment, but now the RTS message is much shorter, such as a single slot length. The Collision Risk interval is accordingly reduced to that same short time. For this reason, the short-form RTS message is less likely to be collided than the prior-art non-short RTS message.

The figure also shows the RTS Reserve interval as covering the CTS message but not the DAT or ACK messages, in contrast to the case of FIG. 2A. This change is intended to handle a situation in which the CTS message is collided (despite the RTS Reserve protection) or otherwise ineffective. Such a CTS collision would render the CTS ineffective. Upon failing to receive a good CTS, the node would backoff instead of sending its DAT. However, the RTS Reserve state would persist for the entire time interval of the intended DAT and ACK, even though the node is not able to transmit then. This spurious Reserve state would needlessly tie up system resources and exclude other nodes form transmitting, throughout a long period, after each CTS collision. To avoid this waste, the RTS Reserve interval in FIG. 2B has been shortened so that it covers only the CTS and the following SIFS gap. Then, the CTS is responsible for reserving the remaining DAT plus ACK time. With that arrangement, if the CTS is damaged, the CTS Reserve state does not occur because the CTS message is unintelligible, and therefore the network does not get obstructed for that duration. On the other hand, if the CTS is good, the node goes ahead and transmits while protected by the CTS Reserve. By making the RTS Reserve state cover only the CTS (and possibly one or a few slots thereafter), the problem of an unnecessary inhibition is solved. If the CTS is good, the subsequent messages are protected; if the CTS is collided, the RTS Reserve state promptly expires, thereby automatically freeing the medium for other messages. No further action is required for the medium to be released after a CTS collision. In embodiments, this improvement can be implemented with a very minor upgrade in the node software, in which each node is caused to withhold transmitting after an RTS only for the length of a CTS instead of the requested Duration. The remainder of the node software, including code that withholds communication for the full CTS Reserve, would remain unchanged. No changes are needed in the base station software. No hardware changes are needed. In addition, nodes that do not have this change may be accommodated transparently. For example, if a node lacks the upgrade, it will continue to withhold for the full RTS requested Duration, and hence the node will be at a competitive disadvantage relative to other nodes that have had the software upgrade.

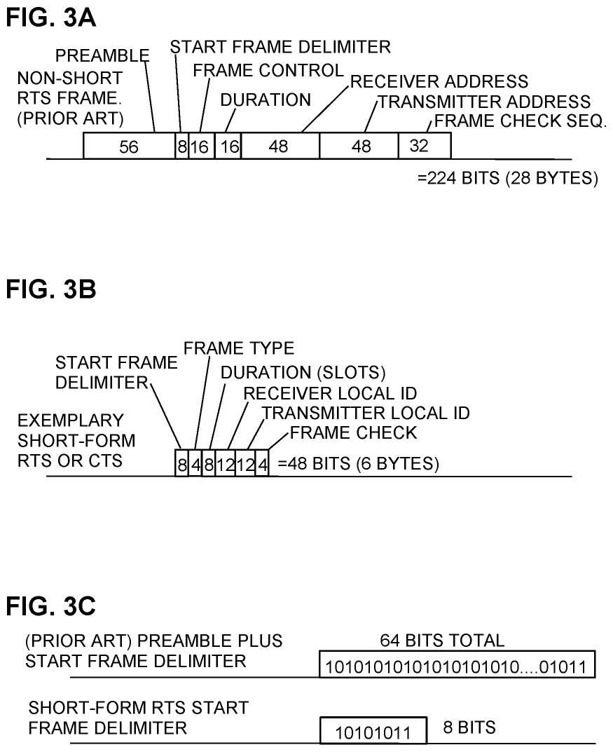

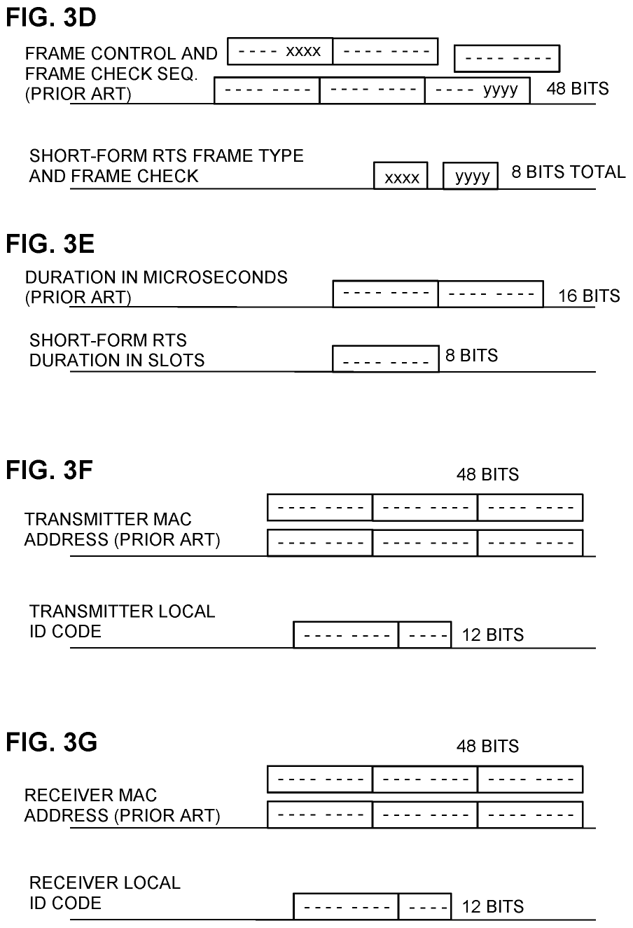

FIG. 3A is a sequence chart showing parts of a prior-art non-short RTS message. The parts shown include the Preamble, the SFD or Start Frame Delimiter, Frame Control, requested Duration, Receiver MAC Address, Transmitter MAC Address, and the FCS or Frame Check Sequence. Each section is labeled with the number of bits, and the total is shown at the right. The non-short RTS is 224 bits or 28 bytes long. (The Preamble and SFD are treated herein as effectively part of the message, rather than a transmitter add-on, because a collision with the Preamble or SFD would destroy the entire message, just as a collision with the other parts of the message.)

The Preamble is a series of alternating ‘1’ and ‘0’ bits. It is intended to allow the receiver to align the receiver's timebase and data rate with the arriving signal. This is important in many LANs where nodes may be separated by tens or hundreds of meters, resulting in a significant time shift due to the speed of light, plus the time involved in receiving, amplifying, detecting, and processing the incoming signal. The timing shift may be different for each node, and may vary with time as various reflectors and absorbers shift in the environment. The long string of alternating ‘1’ and ‘0’ bits allows the receiver to adjust its timebase to that of the signal, thereby obtaining optimal reception despite the time lags mentioned.

The Start Frame Delimiter is an 8-bit extension of the Preamble consisting of six alternating ‘1’ and ‘0’ bits, terminated by two sequential ‘1’ bits, or (10101011) in binary notation. The terminal two bits indicate that the Preamble/SFD is finished and the message data follows next.

The Frame Control section is 16 bits long, containing information such as the message type or subtype, plus a variety of fixed parameters which are not relevant to an RTS message.

The Duration datum is a 16-bit value indicating the time, in microseconds, of the requested NAV or Reserve state, including the time for subsequent CTS, DAT, and ACK messages.

The Receiver Address is the 48-bit MAC address of the receiver (in this case the base station), and the Transmitter Address is the MAC address of the transmitting node.

The Frame Check Sequence or FCS is a 32-bit code, such as a CRC or Cyclic Redundancy Check result, that shows when the message has been collided or otherwise not received in complete form.

FIG. 3B is a sequence chart showing parts of an exemplary short-form RTS message, according to some embodiments. Each segment has been shortened in the depicted case, yet the shortened message is still able to provide the necessary information for networking. The resulting message is 48 bits or 6 bytes long.

In the short-form RTS in the depicted embodiment, the Start Frame Delimiter is 8 bits as usual, but the Preamble has been deleted. Using signal processing electronics, the initial six bits of the Start Frame Delimiter are sufficient to adjust the receiver timebase and the data rate, as discussed in examples below. The final two bits of the Start Frame Delimiter are both ‘1’ bits, thereby indicating that the message data follows. By detecting the Start Frame Delimiter, with no preceding Preamble, the base station may infer that the message is a short-form RTS message and not a prior-art non-short RTS message.

Next is shown an exemplary 4-bit Frame Type section, containing bits that identify the message as a short-form RTS message. As depicted, the Frame Type may be a 4-bit code, thereby being able to distinguish 16 different types. This is more than sufficient to distinguish short-form messages of type RTS, CTS, DAT, and ACK, which make up the bulk of the traffic.

The Duration datum is shown as an 8-bit section, which thus ranges up to 256. Unlike the prior-art non-short RTS, the Duration value in this example indicates the length of the requested Reserve interval in slots, as opposed to microseconds. A range of 256 slots is sufficient to cover the maximum allowed length of a DAT message, rounded up to the nest integer number of slots, in this example. Alternatively, the Duration value could represent the delay in units such as 8-byte or 16-byte units rather than slots, or in multi-microsecond time units such as 4, 8, 16, or other number of microseconds, or other units that provide sufficient range to cover the expected DAT and optionally ACK messages.

The Receiver Local ID and the Transmitter Local ID are each 12-bit codes, in the depicted example, representing the base station and the transmitting node, respectively. As depicted, the base station has selected (or has been assigned) a 12-bit Local ID Code, and has assigned to each node in the LAN a different 12-bit Local ID Code, thereby providing a distinct Local ID Code for each transmitter in the LAN. In the example, the 12-bit range of 4096 is sufficient to provide unambiguous Local ID Codes for each node in the LAN, and in addition to provide a Local ID Code for the base station that is different from the nodes and also distinct from the other base stations in other LANs within detection range of the transmitted signals. In most cases, unless the LAN density is extremely high, all the nodes of all the LANs within range of each other's signals may have distinct Local ID codes by this means. However, in very high-density cases, some of the nodes in different LANs may have the same Local ID Codes. Nevertheless, all messages are unambiguous because they include both the Local ID Code of the node and the Local ID Code of the base station, a unique combination at least among LANs within the signal range.

Finally, the example shows a Frame Check portion, such as a CRC calculation based on the bits of the message. The Frame Check result is shown as 4 bits, which, due to the small size of the short-form RTS, is a sufficient number of bits to detect most collisions.

The total length of the depicted short-form RTS message is 48 bits with these assumptions. In the example, the various sections are sufficient to lock-in the receiver timebase, specify that the message is indeed a short-form RTS type, request a sufficient Reserve interval in slots, uniquely identify the node and the base station of the LAN, and indicate whether the message has been collided. The short-form RTS thereby fulfills all of the normal functions of an RTS message in just 6 bytes.

The example further provides numerous consistency checks for revealing noise or interference or other effects that result in bit errors. For example, the Frame Type must be consistent with the absence of a Preamble and the presence of the Start Frame Delimiter as the leading byte; otherwise the message is discarded. The Duration must not be zero or 256, both of which may be reserved values. The Receiver Local ID must match the base station's Local ID Code, or else the message is assumed to be intended for someone else and is ignored. The Transmitter Local ID Code must match the Local ID Code of one of the nodes in the LAN, or else the message is assumed damaged, and is discarded. The Frame Check must agree with an independent CRC calculation by the receiver; otherwise the message is discarded. If the message passes all of these tests, it is assumed to be a good short-form RTS message.

As mentioned, the transmitting node may, at its discretion, use the prior-art non-short RTS message instead of the short-form RTS configuration. The base station may be configured to receive and interpret whichever type the node sends, including a short-form RTS message or a non-short RTS message. The base station may determine which type the message is, according to the length of the message, or the presence/absence of a Preamble section, or the encoded Frame Type, or otherwise, so long as all of these indicators are mutually consistent. And if they are not consistent, the frame is discarded.

FIG. 3C is a schematic showing bits of a prior-art Preamble and Start Frame Delimiter, along with an exemplary Start Frame Delimiter of an exemplary short-form RTS message, according to some embodiments. The prior-art non-short RTS Preamble is shown with 56 bits of alternating ‘1’ and ‘0’ bits (partially elided for space), followed by the Start Frame Delimiter of ‘10101011’ bits. The second line shows the short-form RTS Start Frame Delimiter, which in this example is the same as the non-short RTS Start Frame Delimiter. The short-form RTS in this example has no Preamble. The alternating bits of the Start Frame Delimiter provide timing data, which allows a base station receiver to lock in its timebase, select the appropriate modulation frequency, and optimize bit detection. Modern fast electronics with timing agility are helpful in adjusting the base station timebase and data rate to those of the received signal. More examples are discussed below.

FIG. 3D is a schematic showing bit positions of the Frame Control and the Frame Check Sequence of a prior-art non-short RTS message, along with an exemplary Frame Type and Frame Check of an exemplary short-form RTS message, according to some embodiments. The prior-art Frame Control portion includes a 4-bit subtype code, shown as x's. This code is set to represent the message type, such as an RTS message. That same code may be used as the Frame Type portion of the short-form RTS message as shown. Alternatively, a different code may be used in the short-form RTS message to indicate that the RTS message is the short-form variety. This terse code may be sufficient to indicate which RTS messages are of the short-form type, and also to differentiate short-form RTS messages from short-form CTS and ACK messages for example. There is no need to specify other fields of the prior-art message such as the Protocol version or Type parameters or other values or headers that either do not change or can be agreed upon in advance. The short-form RTS, in these examples, is recognizable as such because it is shorter than other message types, and also because the lack of a Preamble indicates a short-form type automatically.

The Frame Check Sequence of a prior-art non-short RTS message is also shown, including a terminal or least-significant 4-bit section shown as y's. The short-form RTS may use those 4 bits as the Frame Check portion as shown, or it may use a different encoding to calculate a frame checksum or hash code or parity check or the like to indicate when the message has been distorted. In the example, the Frame Control is 4 bits and the Frame Check is 4 bits, totaling 8 bits. Alternatively, the bit count could be divided as 5 and 3 for example, or otherwise to accommodate a particular protocol need.

FIG. 3E is a schematic showing bit positions of the Duration portion of a prior-art non-short RTS message, along with an exemplary Duration portion of an exemplary short-form RTS message, according to some embodiments. The non-short Duration is 16 bits long and indicates the desired Reserve or NAV time in microseconds. The 16 bits are needed to accommodate the expected range of time encompassing the CTS, DAT, and ACK messages along with spaces etc. However, the requested time depends on many variables such as the modulation rate which may vary. The short-form RTS Duration example, on the other hand, specifies the length of the DAT message in units of slots or other units larger than microseconds, so that the 0-256 range of an 8-bit byte can accommodate the DAT message. In addition, by specifying the Reserve time in slots rather than microseconds, the problem of variable timing and variable data rate is removed, since the number of slots in the DAT is known to the transmitting node. In preparing the CTS, the base station may be configured to take the Duration value of the short-form RTS message, plus further slots representing the ACK message and two SIFS gaps, and thereby specify a Duration in the CTS message to protect the remainder of the message sequence. Since the base station presumably already knows whether it will use a short-form ACK or a non-short ACK, and other parameters, the base station can calculate the required CTS-Reserve interval.

As mentioned, the nodes of the LAN may be configured to detect the RTS message and to withhold transmitting for a time interval corresponding to a CTS message plus one or two SIFS gaps. In other words, the nodes may ignore the Duration value requested by the RTS, and withhold transmitting only for a time corresponding to a standard CTS length instead. Such a short Reserve interval provides protection over a sufficient time for the base station to transmit the CTS, and the CTS then specifies the longer CTS Reserve corresponding to the full DAT and ACK messages. With that arrangement, the CTS is protected by the RTS and the subsequent DAT and ACK are protected by the CTS, but the RTS remains vulnerable to collisions, particularly from hidden nodes at high traffic density. As mentioned, if the CTS is damaged by noise or other mishap, the nodes would not recognize the CTS and therefore would not recognize the long Reserve requested in it. Consequently, after a CTS collision, the nodes that obey only the short RTS Reserve interval may resume activity after a brief listening time, and therefore the medium would avoid being needlessly restricted during the long DAT interval.

FIG. 3F is a schematic showing the bit positions of the Transmitter MAC Address portion of a prior-art non-short RTS message, along with an exemplary Transmitter Local ID Code portion of an exemplary short-form RTS message, according to some embodiments. As mentioned, the MAC address of the base station, and of each node respectively, is a 48-bit code which uniquely identifies the base station or node (or the corresponding processor or related entity), thereby avoiding ambiguities. The Transmitter Local ID Code, on the other hand, is a 12-bit code which identifies the transmitting node among the various nodes of the LAN. Each node may record, in non-transient memory, the Local ID Code for itself, and also the Local ID Code for the base station. The base station may record, in its non-transient memory, a table or equivalent correlating the MAC address of each node with its Local ID Code. Then, upon receiving a short-form RTS message from a node, the base station may extract the Transmitter Local ID Code, and use the stored table to determine the transmitting node's MAC address. The base station may also use the table to verify that the message is from one of its nodes in its LAN, as opposed to some neighboring LAN for example.

FIG. 3G is a schematic showing the bit positions of the Receiver MAC Address portion of a prior-art non-short RTS message, along with an exemplary Receiver Local ID Code portion of an exemplary short-form RTS message, according to some embodiments. The Receiver MAC Address in this example is the MAC address of the base station, and the Receiver Local ID Code is the 12-bit code representing the base station. The base station may be configured to check the Receiver Local ID Code in the short-form RTS message and, if it fails to match the base station's Local ID Code, the base station may ignore the message.

The range of a 12-bit Local ID Code is 1-4096, which may be sufficient to allow each node in a LAN to have a unique Local ID Code among that LAN's nodes. In addition, when multiple LANs are within signal detection of each other, the various base stations must have distinct Local ID Codes. In most cases, the number of nodes that are within signal range of each other is less than 4096, in which case all of the nodes in all of the LANs within range of each other may have different Local ID Codes, thereby providing an unambiguous label for each node. However, the protocol shown in the figure can also accommodate cases of especially high transmitter density, in which more than 4096 nodes are within range of each other. In that case, some nodes within range of each other may be assigned the same Local ID Code. This still does not lead to an ambiguity since, in the example shown, each message includes both the Local ID Code of the node and the Local ID Code of the associated base station. The combination of the Local ID Codes of the node and its base station, included in each message as shown, thereby provides a unique identification of each transmitter and each intended recipient for each message, even in such very high-density conditions that exceed the 12-bit code length. Because the Receiver ID Code specifies a uniquely-identified base station, the combination of the node Local ID Code and base station Local ID Code in the short-form RTS message is sufficient to unambiguously identify the transmitting node, even under high density conditions. The base stations of adjacent LANs may cooperate to ensure that they have different Local ID Codes, using wired communications or otherwise between base stations. If a base station discovers that another LAN's base station has the same Local ID Code, one or both base stations may change their Local ID codes to resolve the issue. To inform their nodes, the base stations could each broadcast a beacon message specifying the change using the full MAC address of the base station to avoid ambiguity.

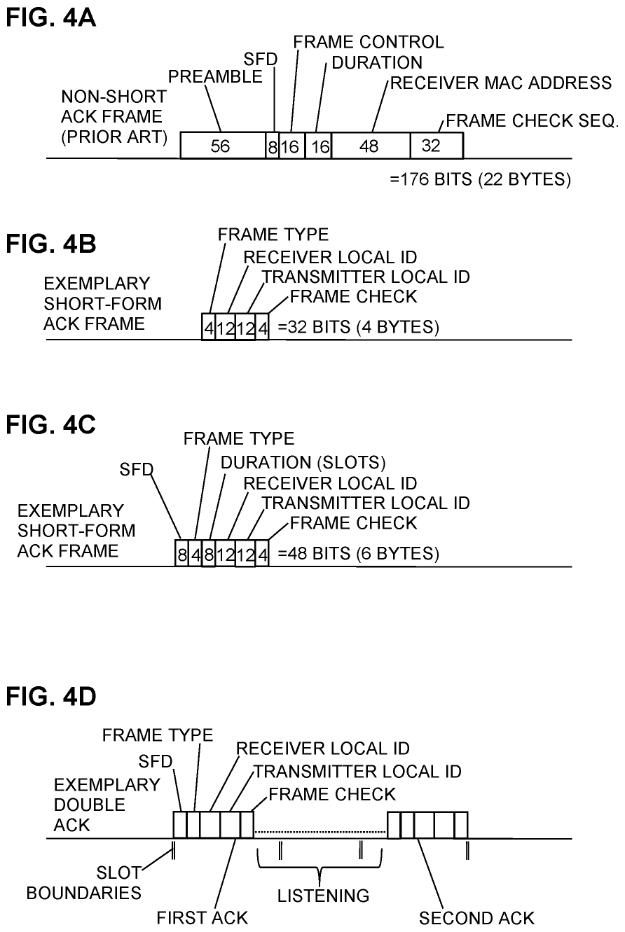

FIG. 4A is a sequence chart showing parts of a prior-art non-short ACK message. Typically the prior-art ACK message does not include a Transmitter MAC Address because ACK frames are sent only by the base station. The frame is otherwise similar to a non-short RTS, and typically includes 176 bits including Preamble and SFD as shown.

FIG. 4B is a sequence chart showing parts of an exemplary short-form ACK message, according to some embodiments. The exemplary short-form ACK message includes, in this depiction, a 4-bit Frame Type specifying it as a short-form ACK message, a 12-bit Receiver Local ID Code identifying the node that sent the original RTS, a 12-bit Transmitter Local ID Code specifying the base station, followed by a 4-bit Frame Check portion, totaling 32 bits or 4 bytes. No Preamble or SFD portions are shown because the timebase and modulation frequency are assumed to have been determined according to the preceding CTS message. No Duration field is shown in this example because it is not needed for an ACK (absent fragmentation management). If, however, the node wishes to send a fragmented DAT stream, the Frame Type field may be used to indicate that the ACK is a continuing ACK or is a terminal ACK in the DAT fragment sequence. In other words, the short-form messages may include short-form RTS, CTS, DAT, continuing ACK, and terminal ACK types.

In contrast to the prior-art non-short ACK, this example includes a field for the base station Local ID Code. An advantage of including the base station Local ID Code in the ACK message, as mentioned, may be to avoid confusion in situations where multiple LANs crowd into an overlapping service area, so that each message includes both a node Local ID Code and a base station Local ID Code, and therefore is uniquely identified. By identifying both the node and the base station in each ACK message, nodes can determine instantly whether the message applies to its LAN or some other LAN. In addition, providing the Local ID Codes of both the node and base station helps to detect otherwise unseen interference or errors, since a random change in either of the Local ID Codes would be highly unlikely to correspond to the correct values of a current node and its base station, in any of the LANs reachable by the signals. It may be noted that this protection is provided despite the very short codes in the example. The Local ID Codes of the node and base station together total only three bytes, which is only half of a single MAC address.

FIG. 4C is a sequence chart showing parts of another exemplary short-form ACK message, according to some embodiments. Here the ACK message is similar to that of FIG. 4B, with frame type, receiver and transmitter Local ID Codes, and a terminal Frame Check field. In addition, the example short-form ACK now includes an 8-bit SFD portion and an 8-bit Duration portion. The SFD enables the node to refresh the timebase and modulation parameters after the long DAT message, during which the timing may have drifted. The Duration field facilitates fragmentation management by specifying how long the other nodes must refrain from transmitting to avoid colliding with the next DAT fragment. The total length is now 48 bits.

FIG. 4D is a sequence chart showing an exemplary Double ACK message, according to some embodiments. Two successive short-form ACK messages may be sent by the base station to confirm that a DAT message was received in good order. The first and second ACK messages may be separated by one or more slots having no transmission, as indicated by the “listening” interval. The base station may be configured to detect interfering carrier signals or other signals during the listening time and, if any signal is detected, may wait until the channel is clear before transmitting the second ACK. In this way the base station can further ensure that the previous DAT message was received in good order, and the node does not have to re-transmit it.

The Double ACK is intended to address a costly time-waster in which a node has successfully completed the RTS-CTS-DAT sequence but did not receive an ACK acknowledgement due to noise or interference that collided only with the ACK. The base station has no way of determining that the ACK was collided, and the node has no way of determining that the DAT was successfully received. In that case, unfortunately, the node is required to perform a backoff delay and then repeat the entire process again by re-transmitting the same DAT message, which is an unnecessary time-waster if the initial transmission was successful. To avoid this, especially in a high-traffic or high-interference environment, the base station may send the ACK twice as shown. An advantage of sending two spaced-apart ACK messages may be that if one of the ACK messages is damaged by interference, the other one would likely get through and would thus assure the node that its DAT was received, thereby avoiding having to repeat the message sequence again. This advantage would apply whether the base station transmits non-short ACK messages or short-form ACK messages, but the short messages would take less time. In the example shown, the two short-form ACK messages occupy just three six-byte slots, of which one is a listening slot, thereby using only minimal resources. In high traffic density or noisy conditions, the small extra time involved in confirming the acknowledgement with a Double ACK may be small compared to the cost of unnecessarily re-transmitting the DAT message after an ACK has been damaged.

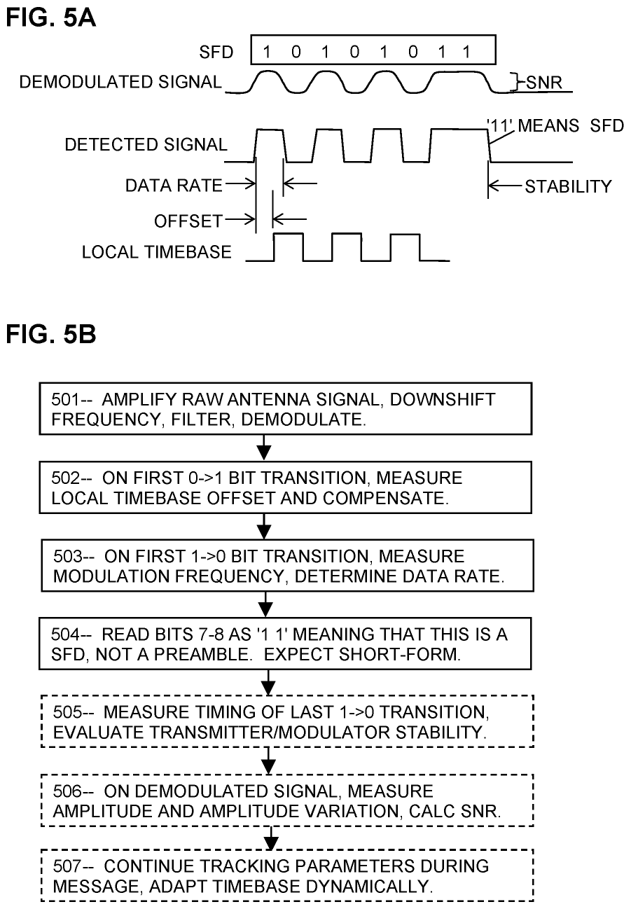

FIG. 5A is a sequence chart showing how an exemplary Start Frame Delimiter or SFD byte may enable the receiver to align the local timebase and select the data rate of the message, without the need for a Preamble, according to some embodiments. The SFD bits are shown in the first line as ‘10101011’. The second line shows an amplified and demodulated analog signal corresponding to the SFD (processing delays are ignored). The third line shows the detected digital signal, which may be obtained from the demodulated analog signal using a threshold voltage comparator or a discriminator or the like to discriminate ‘0’ and ‘1’ bits. The local timebase waveform is shown, shifted in phase by an “offset” time. (The offset refers to the modulation phase, not to the RF phase which the demodulator removes.) The receiver may be configured to shift the local timebase or the detected signal by that offset amount, so as to bring the local timebase into alignment with the received signal for optimal reception. In addition, the receiver may be configured to measure the temporal width of the first ‘1’ bit and thereby determine the modulation frequency, and may then select the closest allowed data rate for decoding the rest of the message. The receiver may also detect that bits 7 and 8 are both ‘1’ bits, which indicates that the 8-bit byte is an SFD and not part of a Preamble (which consists of alternating ‘1’ and ‘0’ bits only). Since the message lacks a separate Preamble, the receiver (or its controlling processor) may determine that the message is a short-form message and can process it accordingly. In addition, the receiver may be configured to compare the timing of the last transition (bit 8) with that of bit 1, and thereby reveal stability issues of the transmitting timebase or modulation stage, among other potential problems. In addition, the receiver may be configured to measure the amplitude of the demodulated analog signal, and to measure the variation in amplitudes of the several bits in the SFD, and thereby determine the SNR or signal-to-noise ratio. The SNR may also be affected by timing variations. Thereafter, while the rest of the message is received, the receiver may continue to measure the offset based on the various bit transitions, and may adapt the local timebase dynamically to maintain alignment despite variations in transmitter or environmental parameters that may affect the signal timing.

FIG. 5B is a flowchart showing an exemplary method for a receiver to determine the signal parameters from the SFD, according to some embodiments. At 501, the receiver may process the raw signal from the antenna by amplifying, downshifting, filtering, and/or demodulating to reveal the ‘1’ and ‘0’ bits of the signal, thereby producing a digital or analog waveform such as the demodulated signal of FIG. 5A. At 502, the receiver may detect, in the demodulated signal, the first bit transition, and may compare it to a local oscillator timebase, thereby obtaining an offset in time between the bit transition and a corresponding transition of the local oscillator. The receiver may then apply a (digital or analog) time shift to the local timebase to bring it into alignment with the demodulated signal timing. In some embodiments, the receiver may maintain a plurality of local timebases which are shifted from each other by a predetermined amount, such as 90 degrees, that is, quadrature time bases. Then the detected signal will be within at most 22.5 degrees from one of those quadrature timebases, thereby reducing the amount of offset required and simplifying the timebase adjustment. Thereafter, the demodulated signal or the local timebase may be incrementally time-shifted to keep them in alignment during the rest of the message.

At 503, the receiver measures the width of the first bit in the SFD and thereby determines the modulation frequency or data rate. Many transmitters are able to change the modulation frequency to compensate for noisy conditions and other problems. However, the transmitter is allowed to use only a specific set of modulation frequencies as determined by the LAN. Therefore, the receiver, upon measuring the time between the beginning and end of the first bit, may determine which of the allowed modulation frequencies is closest to the observed interval, and can process the rest of the message accordingly using that data rate.

At 504, the receiver may identify bits 7 and 8 as both ‘1’ bits, which indicates that the byte is an SFD byte, and also that the message is a short-form type since no Preamble is present.

At 505, the receiver may perform a number of additional checks, shown in dash. By measuring the timing of the last bit transition and comparing to the first bit width, the receiver can evaluate the transmitter/modulator stability. Many sources of noise also show up as timing jitter in the bit transitions. At 506, the receiver may process the demodulated analog signal, or an ADC digitized form of the analog signal, and can measure the amplitude of the signal according to the difference between the average values of the ‘1’ and ‘0’ bits. The receiver may also evaluate the noise by determining the variation in amplitude for each successive bit, relative to the average amplitude. The receiver may then calculate a signal-to-noise ratio from the amplitude variations, which is different from the SNR obtained from the timing jitter. At 507, the receiver may continue to track the timing of the bit transitions in the subsequent message body and thereby compensate in real time for a drift or variation in timing due, for example, to transmitter properties or environmental effects or external noise sources. The receiver can also correlate the amplitude and timing measurements of bits in the subsequent message to improve each of the signal and noise determinations, among other diagnostics.

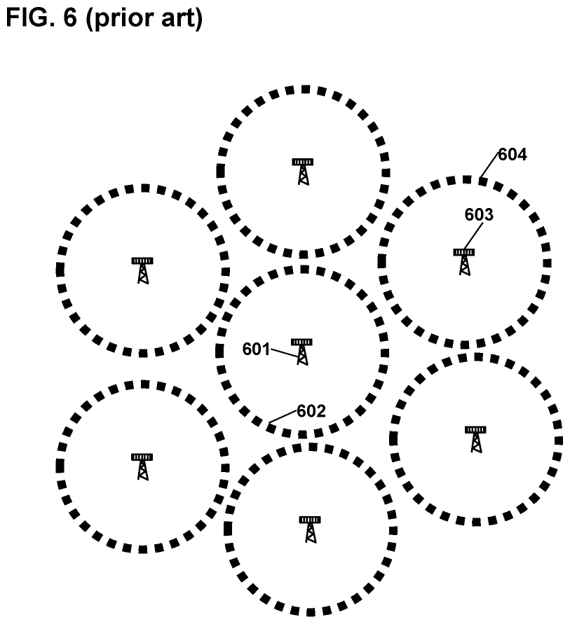

FIG. 6 is a schematic illustration of multiple LANs in close proximity, according to some embodiments. Depicted are a base station 601 and its nodes 603 including a central LAN. Around this are six additional LANs such as the additional base station 603 and its additional nodes 604. The base stations 601 and 603 may be configured to assign a different Local ID Code to each base station 601 and 603, so that the various LANs that are within signal range of each of each other can uniquely identify messages to/from their respective nodes without confusion. In addition, the base station 601 may be configured to assign a different Local ID Code to each of the nodes 602 in its LAN, and likewise the additional base station 603 may be configured to assign different Local ID Codes to each of the additional nodes 604 in its LAN, and so forth. Alternatively, a higher-level management entity may assign the Local ID Codes, such as a regional or national coordinator that allocates Local ID Codes to LANs according to geographical area for example.

In one embodiment, the number of nodes and base stations that are within detectable signal range of each other is less than the number of Local ID Codes (such as 4096 for a 12-bit code or 65536 for a 16-bit code), so that each node and base station within signal reach of each other can have a different Local ID Code. In other embodiments, however, the number of nodes may be too high, or the density of LANs may be too high, for each node to have a different Local ID Code from all the other nodes in other LANs, although all the nodes in any particular LAN must have different Local ID codes from each other. For example, nodes in adjacent LANs may end up with the same Local ID Code when more than 4096 nodes are within detectable signal range of each other. In that case, the ambiguity problem may be solved by arranging that each message between a node and its base station includes both the Local ID Code of the node and the Local ID Code of the base station, as mentioned above. Since the base stations within signal reach of each other must have different Local ID Codes, the messages that include both the node and base station Local ID Codes may thereby be uniquely ascribed to the correct LAN. In extreme density situations wherein the number of interfering base stations exceeds the number of unique codes, then either the base stations may reduce their signal power to shorten the interference range and thereby impact fewer LANS, or the base stations may revert to a non-short RTS protocol in which the full 48-bit MAC address of each node and base station is used. It is expected, however, that in such a dense and crowded wireless environment, many other communication problems will occur long before the Local ID Code range is exhausted.

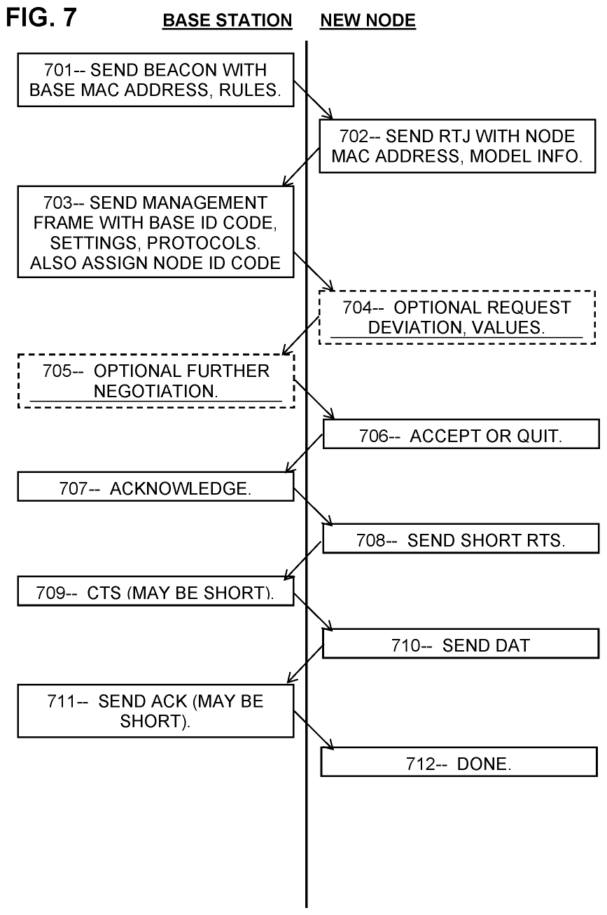

FIG. 7 is a flowchart showing an exemplary series of messages between a base station and a newly arriving node, according to some embodiments. The newly arriving node and the base station exchange messages to determine if the node can meet the performance requirements of the LAN, and if so, to induct the node into the LAN. At 701, the base station transmits a beacon message describing the rules and parameters of the LAN, and also providing the MAC address of the base station. At 702, the node responds by sending an RTJ (Request-to-Join) message including information about the node such as its MAC address, its make and model, and other information that would enable the base station to assess whether the node can join the LAN. At 703, the base station sends a message assigning the Local ID Code of the base station, and optionally specifying more details about protocols and parameters not covered in the beacon 701. Alternatively the base station may provide the Local ID Code of the new node at a later stage, such as after approval. At 704, optionally (shown in dash), the node may request a deviation from the rules or parameters as specified, or may select a particular parameter among a range or list that the base station has provided, or other follow-on negotiation. At 705, optionally, the base station may grant the requested choices or deviations, reject same, or otherwise continue the negotiations with further messages (not shown). The base station may provide a provisional acceptance of the node into the LAN at this point, or at 703, or later depending on circumstances and protocol settings. At 706, the node may accept the (possibly revised) rules and parameters for joining the LAN, or may reject them and quit the discussion without joining. At 707, the base station may acknowledge the acceptance and thereby induct or accept the node into the LAN. Further steps such as authentication and security requirements are not shown. At some time thereafter, at 708, the node may send its first non-management message, an RTS which in the depicted case is a short-form RTS that includes the Local ID Code of the base station and also the Local ID Code of the node which was just assigned. At 709 the base station acknowledges the RTS by transmitting a CTS, which may be a short-form CTS that incorporates one or more of the shortening means disclosed herein, or it may be a non-short CTS according to the prior art. In either case, at 710 the node responds to the CTS by sending a DAT message that contains the data that the node wishes to transfer. If the DAT is received in good order, the base station at 711 sends an ACK acknowledgement message, which may be a short-form ACK message incorporating one or more of the shortening means disclosed herein, or may be a non-short ACK message according to the prior art. At 712, the node receives the ACK message and is done.

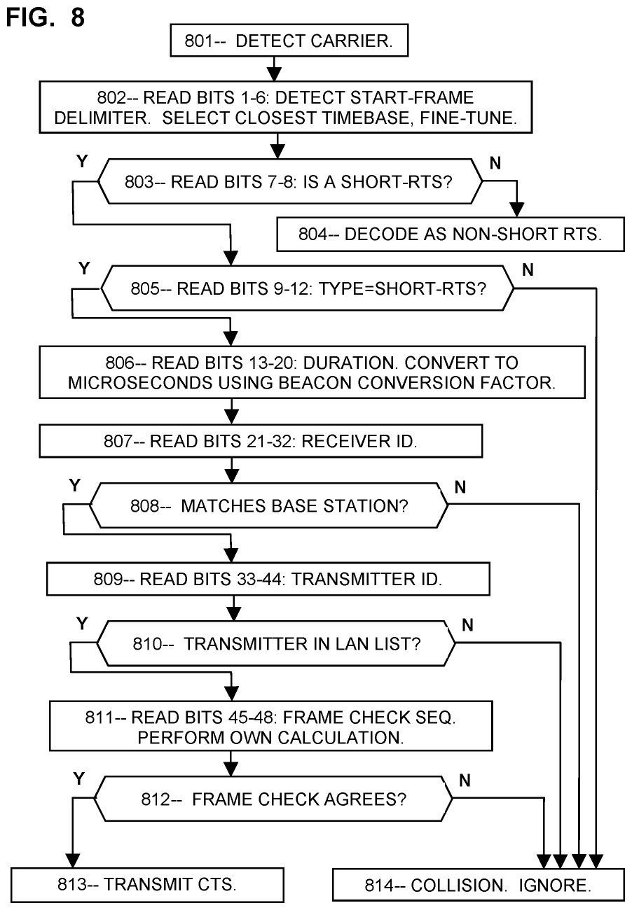

FIG. 8 is a flowchart showing an exemplary method for a base station to determine whether a short-form RTS message is corrupted, according to some embodiments. At 801, the base station detects a carrier signal and determines that a message is being sent. At 802 the base station detects and interprets (or “reads”) the first six bits of the message, which are expected to be alternating ‘1’ and ‘0’ bits of a Preamble or, if the message is a short-form RTS, the SFD structure. The receiver focuses on the time of transition of the first six bits, specifically the six transitions between ‘1’ and ‘0’ bits, and optionally the seventh transition as well. The receiver selects the closest local timebase and then adjusts the timing to match the detected signal. Using the same bits, the receiver also selects the data rate from among the allowed modulation frequencies. At 803, the base station reads bits 7 and 8. If they are both ‘1’ bits, the base station determines that the message is a short-form message, and since it is initiated by a node, it must be a short-form RTS message. Thus bits 1-6 comprise an abbreviated Preamble and bits 7-8 indicate that the rest of the message follows. If the first byte of the message is an SFD, the message is a short-form RTS. If bits 7-8 are not both ‘1’ bits, then at 804 the message is interpreted as a prior-art non-short RTS message with a Preamble.

At 805, assuming that the message is a short-form RTS, and that bits 7-8 are both ‘1’ bits, then the Frame Type bits 9-12 are read. The base station checks that the Frame Type bits agree with the conclusion that the message is a short-form RTS. If not, the message is corrupted, in which case the base station ignores the message at 814. If the Frame Type bits agree with the SFD bits, then at 806 the Duration bits 13-20 are read, specifying the time (in slots or other units) that the transmitting node wishes to reserve the medium. In a first version, the base station converts the requested Duration time to microseconds using a predetermined slot-to-microsecond conversion factor based on the data rate. In a second version, the base station leaves the Duration time in slots (or other units) for subsequent transmissions, but adds the ACK time to cover the expected Reserve interval. At 807 the base station reads bits 21-32, which contain the Local ID Code of the receiver, which is the base station in this case. Thus the transmitting node specifies the base station and thereby identifies which particular LAN is involved. At 808, the base station compares the Receiver Local ID Code of the message with its own Local ID Code. If they fail to match, then either the message is corrupted or it is intended for a different base station, and in either case the message is ignored at 814. If the receiver Local ID Code matches that of the base station, then at 809 the base station reads bits 33-44 which in this example contain the Local ID Code of the transmitter, that is, the node. The base station also checks that the node Local ID Code in the message agrees with a list of values that the base station has stored in non-transient memory, tabulating the members of its LAN. If there is a match with one of the LAN members, the base station recognizes the message as coming from one of its nodes. If the transmitter Local ID Code in the message does not agree with any of the node values in the stored table, then the message is corrupted and is ignored at 814. Assuming that the node Local ID Code matches one of the list members at 810, the base station then reads bits 45-48 at 811, which in this example contain a Frame Check Sequence. The base station may then perform its own calculation of the expected Frame Check Sequence based on the bits that it has read. If the two values differ at 812, the message is ignored at 814. If the Frame Check Sequence agrees, and all the other checks agree, then at 813 the base station accepts the short-form RTS message and then transmits a CTS message to the node. The CTS enables the node to transmit its DAT message (not shown). In this way, the base station performs multiple tests on the short-form RTS message to establish whether it is corrupted, whether it is intended for that particular base station, and whether it is a short-form RTS or non-short RTS message, before proceeding.

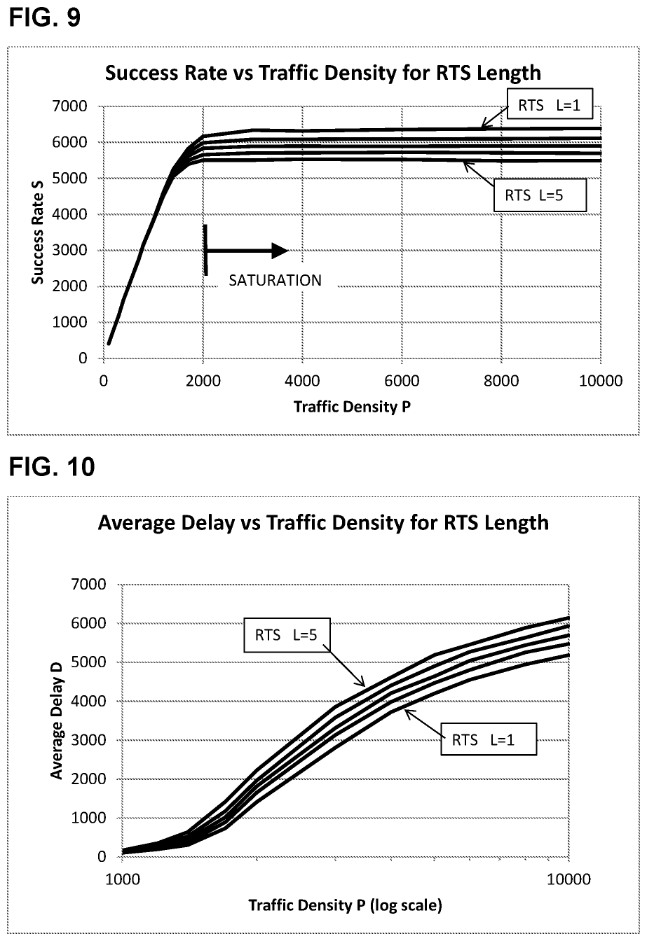

FIG. 9 is a chart showing the success rate of nodes in a simulated LAN using exemplary RTS messages of various lengths. A computer simulation was prepared to test the operation of a LAN and to determine the effect of using shorter RTS lengths. The simulated LAN included 40 nodes around a base station, competing for an opportunity to transmit, with variable traffic density ranging from low to high density. The model tracked the success rate S versus the traffic density P for RTS messages of length L of 1 to 5 slots. Each slot was 6 bytes in this simulation; however, the results are largely independent of the bytes per slot, because the traffic density was specified on a per-slot basis, so the byte factor canceled. The 1-slot RTS corresponds to the short-form RTS discussed above, with 6 bytes. The 5-slot RTS corresponds closely to the prior-art non-short RTS with 28 bytes. The other RTS lengths, of 2, 3, and 4 slots, correspond to other versions of the short-form RTS messages that incorporate some but not all of the shortening means discussed herein. The success rate S equals the number of RTS-CTS-DAT-ACK completions, per million slots. The traffic density P equals 10 million times the probability that a particular node will seek to transmit a new RTS in a particular slot.

The chart shows that at low to medium traffic density, P<1500 on the horizontal scale, the success rate rose according to the traffic density and was relatively independent of the RTS length. This is expected because collisions are rare at low traffic density, and therefore the RTS length has little effect. As the traffic density was increased P>2000, the opposite was observed: the success rate became relatively independent of the traffic density, but was dependent on the RTS length. At high traffic density, most of the nodes spent most of the time in backoff, waiting to transmit. This is indicated as “saturation” on the chart. Since a node in backoff was not permitted to generate a new message until the previous one was completed, the success rate became constant vs. P. However, the collision rate depended on the RTS length, and this affected the overall success rate. At high traffic density, as the RTS length L was reduced from 5 slots to 1 slot, the measured success rate increased by 15%. This demonstrates that short-form RTS messages can provide higher message success rates by avoiding collisions with hidden nodes, according to some embodiments.

FIG. 10 is a chart showing the average delay time of nodes in the simulated LAN using exemplary RTS messages of various lengths. The delay time D equals the total amount of time (in slots) that each node spent in backoff delay, divided by the number of successful completions, per million slots. The chart shows that the average delay time increased with traffic density, as expected. In addition, the average delay time decreased by 17% as the RTS length was reduced from 5 slots to 1 slot. This is due to the reduced number of collisions as the RTS Collision Risk interval was reduced. The results indicate that the average delay time can be reduced by using a short-form RTS message protocol.

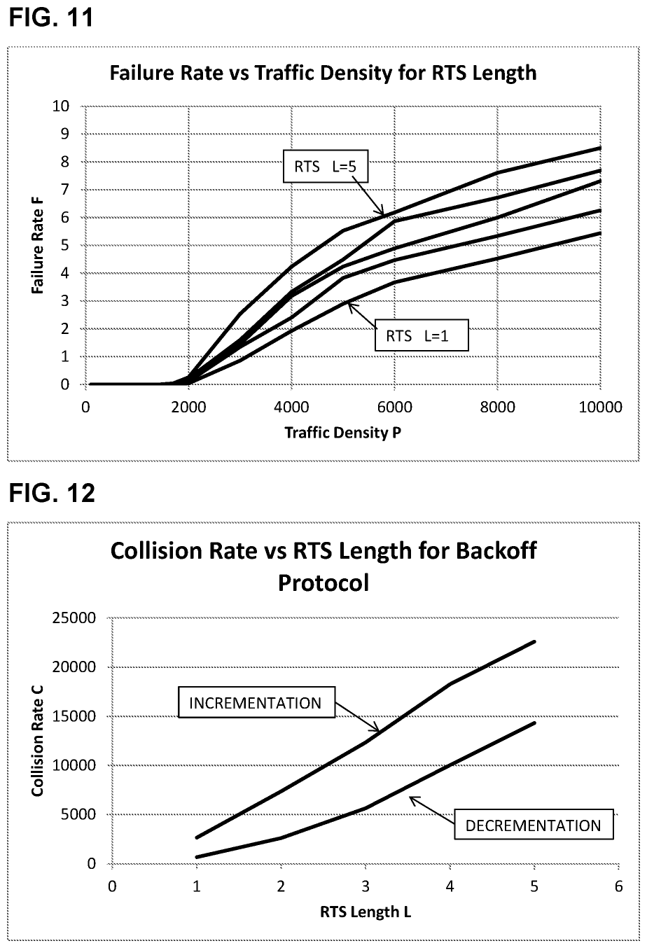

FIG. 11 is a chart showing the message failure rate of nodes in the simulated LAN using exemplary RTS messages of various lengths. A message was counted as a failure if it was delayed 20 or more times. The failure rate F equals the number of messages that failed and were dropped, per 1 million slots. As expected, the failure rate increased with traffic density, from zero at low density to higher failure rates at high traffic density. As the RTS length was reduced from 5 slots to 1 slot, the failure rate decreased by a factor of 1.6, due largely to the reduced amount of time that the short RTS messages were vulnerable to collisions from hidden nodes. The results demonstrate that the message failure rate at high traffic density can be improved by use of a short-form RTS.

FIG. 12 is a chart showing the collision rate of nodes in the simulated LAN using exemplary RTS messages of various lengths. Incrementation and Decrementation delay protocols were compared. As mentioned, Incrementation protocols increase the contention window (typically doubled) upon each backoff delay. The prior-art “binary exponential delay” protocol is an Incrementation protocol, which imposes longer delays, on average, after each retry, up to a maximum delay of 4000 slots in the model. In contrast, a Decrementation protocol provides for the average backoff delay to be decreased upon each delay. Decreasing the average delay thereby imposes shorter average delays for nodes that have waited the longest. The results presented in FIGS. 9, 10, and 11 were obtained using an Incrementation protocol, specifically the binary exponential delay protocol.

The simulation was carried out twice, once for a conventional Incrementation protocol and again for a Decrementation protocol using parameters discussed below. In the figure, the collision rate C, per 1 million slots, is plotted versus the RTS length in slots, for both Incrementation and Decrementation protocols at the highest traffic density P=10,000. The chart shows that both Incrementation and Decrementation protocols had a similar dependence on RTS length L: low collision rates at the shortest RTS lengths and higher collision rates for the 5-slot RTS. Using the Incrementation protocol, the collision rate was 8.5 times higher for the 5-slot RTS than for the 1-slot RTS. With Decrementation, the advantage of short-form RTS is even higher, a factor of 21 for the 5-slot RTS relative to the 1-slot RTS length. This is a consequence of the longer RTS messages being vulnerable to hidden node collisions for a longer time. The model also indicated that the Decrementation collision rate had substantially lower collision rates than the Incrementation collision rate, for all RTS lengths tested. This may be due to the smaller number of RTS messages transmitted per successful completion with Decrementation than with Incrementation. The results thus indicate that an exemplary short-form RTS can substantially reduce the collision rate, and that Decrementation provides the lowest collision rates, in the examples tested.

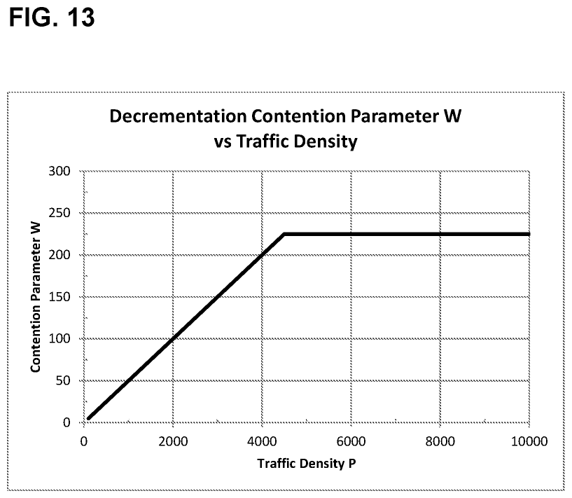

FIG. 13 is a chart showing an exemplary formula for setting the contention window parameters of an exemplary Decrementation protocol. The Decrementation delay was determined by three parameters: CWmin, the mandatory waiting time, CWwid, the width of the contention window, and CWdel, the amount by which the other parameters are reduced upon each retry attempt. In the simulation, the Decrementation delay parameters were based on a parameter W that was set according to the traffic density P, as shown in the figure. The waiting time CWmin was set equal to 0.9*W, the contention window width CWwid was set at 1.1*W, and the CWdel parameter at 0.1*W. At low traffic density, W is low and each of the delay parameters is also small, which results in short backoff delays, as expected for low traffic density conditions. As the traffic density was increased, the W parameter was linearly increased up to W=225, thereby providing longer delay parameters in proportion. The linear increase was then stopped at a traffic density of P=4500, above which the W parameter was held constant at W=225. In this way the Decrementation protocol was adjusted according to the traffic density to provide sufficient delays and to avoid collisions, but not so much delay that the messages are unnecessarily inhibited, in the cases studied.

The systems and methods may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, or sooner, are loaded into random access memory. Inputs to the application, e.g., from the plurality of users or from any one user, may be by any number of appropriate computer input devices. For example, users may employ vehicular controls, as well as a keyboard, mouse, touchscreen, joystick, trackpad, other pointing device, or any other such computer input device to input data relevant to the calculations. Data may also be input by way of one or more sensors on the robot, an inserted memory chip, hard drive, flash drives, flash memory, optical media, magnetic media, or any other type of file—storing medium. The outputs may be delivered to a user by way of signals transmitted to robot steering and throttle controls, a video graphics card or integrated graphics chipset coupled to a display that maybe seen by a user. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., embedded systems and processors, personal computers, laptop computers, notebook computers, net book computers, handheld computers, personal digital assistants, mobile phones, smart phones, tablet computers, and also on devices specifically designed for these purpose. In one implementation, a user of a smart phone or WiFi-connected device downloads a copy of the application to their device from a server using a wireless Internet connection. An appropriate authentication procedure and secure transaction process may provide for payment to be made to the seller. The application may download over the mobile connection, or over the WiFi or other wireless network connection. The application may then be run by the user. Such a networked system may provide a suitable computing environment for an implementation in which a plurality of users provide separate inputs to the system and method.

The systems and methods disclosed herein can provide numerous advantages not obtainable with prior-art wireless protocols. At medium and high traffic densities, embodiments of the systems and methods can reduce the message collision rate substantially, increase throughput, reduce average delays per message, and reduce the number of failed communication attemtps, especially at high traffic density including traffic densities well above saturation conditions. Protocols according to present principles can be beneficially employed in numerous applications, including but not limited to vehicles (e.g., roadway, airborne, waterborne, autonomous, semi-autonomous, human-driven, rental scooters, truck trackers, etc.), personal devices (e.g., mobile phones, health monitors, personal locators, pet locators, etc.), computers (e.g., tablet, laptop, desktop, server, embedded, single-chip, portable, fixed-site, etc.), interconnected devices (e.g., “smart” appliances and controls, entertainment devices, voice-activated assistants, home security systems, cameras, etc.), emergency call and response systems (e.g., 911 servers, law enforcement systems, fire response systems, health emergency systems, national defense systems, etc.), responsive monitors and alarms (e.g., intrusion monitors, fire or smoke alarms, weather and other environmental, highway traffic, pedestrian traffic, earthquake monitors, etc.), office communication applications (e.g., communication between computers, printers, scanners, phones, data storage devices, marketing and presentation display devices, and other wireless business devices), manufacturing (e.g., automated producton and machine tools, sorters and transporters with wireless control, packaging and weighing and shipping stations that track individual orders, quality control sensors and connected servers, assembly robots, testing robots, product singulators and counters, packagers, labelers, etc.) and innumerable other products that communicate using radio waves. The practicality and usefulness of embodiments according to present principles will become greatly augmented with the widespread adoption of 5G and subsequent wireless generations (such as 6G and following subsequent and future technologies). Collision avoidance protocols such as the short-form RTS and ACK messages will be needed even more as congestion continues to rise in the limited bandwidth available.

It is to be understood that the foregoing description is not a definition of the invention but is a description of one or more preferred exemplary embodiments of the invention. The invention is not limited to the particular embodiments(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater, or different steps than that shown here. All such other embodiments, changes, and modifications are intended to come within the scope of the appended claims.

As used in this specification and claims, the terms “for example”, “e.g.”, “for instance”, “such as”, and “like” and the terms “comprising”, “having”, “including”, and their other verb forms, when used in conjunction with a listing of one or more components or other items, are each to be construed as open-ended, meaning that the listing is not to be considered as excluding other additional components or items. Other terms are to be construed using their broadest reasonable meaning unless they are used in a context that requires a different interpretation.

1. A system for wireless communication, comprising a local area network including a base station in signal communication with a plurality of user nodes, wherein:
each user node is persistently associated with a medium access control (MAC) address;
each user node is persistently associated with a local identification code comprising fewer bits than the MAC address of the user node; and
each user node is configured to transmit a request message to the base station, the request message requesting permission to transmit a data message, the request message including the local identification code of the transmitting user node.

2. The system of claim 1, wherein the request message is transmitted according to 5G or 6G technology.

3. The system of claim 1, wherein each local identification code is different from all the other local identification codes of the local area network.

4. The system of claim 1, wherein the request message includes:
a first field comprising alternating ‘1’ bits and ‘0’ bits in succession, the field having a total length of six bits; and
a second field comprising two successive ‘1’ bits, the second field immediately following the first field;
wherein the base station is configured to determine, from the alternating ‘1’ and ‘0’ bits, a time-base and a modulation rate of the request message.

5. The system of claim 1, wherein the request message includes:
a message-type field indicating that the message is a request message; and
an error-detection field indicating whether the request message has been corrupted;
wherein the sum of the lengths of the message-type field plus the error-detection field is at most eight bits.

6. The system of claim 1, wherein the request message includes a duration field specifying a time interval during which interfering messages are to be excluded, the duration field comprising at most eight bits.

7. The system of claim 1, wherein the request message has a length of at most 48 bits.

8. The system of claim 1, wherein:
a first user node is configured to transmit a first request message that includes a local identification code of the first user node;
a second user node is configured to transmit a second request message that include a MAC address of the second user node; and
the base station is configured to receive and interpret both the first and second request messages.

9. The system of claim 1, wherein a particular user node is configured to transmit a data message and then to receive an acknowledgement message responsive to the data message, the acknowledgement message comprising a local identification code of the particular user node.

10. The system of claim 9, wherein the acknowledgement message further includes a portion comprising alternating ‘0’ and ‘1’ bits followed by two ‘1’ bits in succession.

11. The system of claim 9, wherein the particular user node is further configured to receive, after transmitting the data message, two spaced-apart acknowledgement messages related to the data message.

12. The system of claim 1, wherein each node is configured to wait, after transmitting a request message and failing to receive a responsive permission message, for a randomly selected portion of a contention window, and then to re-transmit the request message, wherein the contention window is made shorter after each failure to receive the responsive permission message.

13. The system of claim 12, wherein each node is configured to calculate an initial contention window length according to a formula based at least in part on a wireless traffic density.

14. The system of claim 1, wherein wherein the local identification code comprises at most 12 bits.

15. Non-transitory computer-readable media in a base station of a wireless network, the base station in signal communication with a plurality of user nodes, the media comprising instructions that when executed by a computing environment cause a method to be performed, the method comprising:
transmitting, by the base station, a first message specifying a base local identification code, the base local identification code being persistently associated with the base station and comprising at most 16 bits;
then receiving, by the base station, from a new user node, a second message requesting admission to the local area network; and
then transmitting, by the base station, to the new user node, a third message specifying a node local identification code, the node local identification code being persistently associated with the new user node and comprising at most 16 bits.

16. The method of claim 15, further comprising receiving, by the base station, from the new user node, a request message requesting permission to transmit a data message, wherein the first 8 bits of the request message comprise a binary sequence of ‘10101011’ bits.

17. The method of claim 16, wherein the request message comprises a first portion indicating that the request message is a request message, and a second portion indicating an error-detection code, wherein the first and second portions cumulatively total at most 8 bits.

18. An artificial intelligence structure comprising software arranged in a computer, the artificial intelligence structure comprising:
a first plurality of inputs, each input comprising a network parameter related to a wireless network;
a second plurality of internal functions, each internal function operably linked to one or more of the inputs or one or more of the internal functions; and
a third plurality of outputs, each output operably linked to one or more of the internal functions, each output comprising a prediction of future network performance;
wherein:
each of the internal functions comprises one or more adjustable variables;
each of the adjustable variables has been adjusted according to network data; and
the network data comprise measurements of the network parameters.

19. The artificial intelligence structure of claim 18, further comprising an algorithm configured to take as input one or more of the network parameters and to provide as output one or more of the predictions of future network performance.

20. The artificial intelligence structure of claim 19, wherein the algorithm is installed in a memory of a base station of a wireless network.
